(19) United States
(12) Patent Application Publication
(10) Pub. No.: US 2025/0028056 A1
(43) Pub. Date: Jan. 23, 2025

(54) SYSTEMS AND METHODS FOR IDENTIFYING CORRELATED USERS

(71) Applicant: Capital One Services, LLC, McLean, VA (US)

(72) Inventors: Joshua EDWARDS, Philadelphia, PA (US); Tyler MAIMAN, Melville, NY (US); Samuel YIP, East Brunswick, NJ (US); Bryant YEE, Silver Spring, MD (US); Haytham YAGHI, Alexandria, VA (US)

(73) Assignee: Capital One Services, LLC, McLean, VA (US)

(21) Appl. No.: 18/355,532

(22) Filed: Jul. 20, 2023

(51) Int. Cl. G01S 19/14; G06F 21/31

(52) U.S. Cl. CPC G01S 19/14; G06F 21/31

(57) ABSTRACT

A method for identifying correlated users. The method may include: receiving connection data for each of one or more other users; determining a degree of connection of the one or more other users to the first user; receiving query information from one or more electronic devices associated with the first user; receiving authentication information for each of the one or more other users; determining a destination of the first user based on the query information; determining one or more other user destinations for the one or more other users; identifying one or more correlated other users from the one or more other users by comparing the destination of the first user with user destinations of the one or more other users and further based on the degree of connection of the one or more other users; and providing the identified one or more correlated other users to the first user.

### TECHNICAL FIELD

Various embodiments of this disclosure relate generally to techniques for identifying correlated users, and, more particularly, to systems and methods for identifying personal contacts for users to network with based on similar characteristics, such as an association with a particular location.

### BACKGROUND

Traveling to new places can be an exciting and enriching experience, but many travelers encounter difficulties in finding reliable and personalized recommendations for activities and restaurants. Current search algorithms and computer-based methods for providing recommendations often produce generic or impersonal results that fail to meet the specific preferences or needs of the traveler, primarily due to their inability to effectively consider correlations between users and connections when serving reviews and recommendations. This can lead to a less enjoyable and less customized travel experience.

The issue may be exacerbated for travelers visiting a destination for the first time, as they might be unfamiliar with local culture and customs. These travelers may struggle to find the best restaurants or activities that align with their interests, missing out on opportunities to fully experience the destination. A primary reason for this is the difficulty in determining the degree of connection between users and incorporating this information into personalized recommendations, which current technical solutions fail to address adequately.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for identifying correlated users.

In one aspect, an exemplary embodiment of a method for identifying correlated users may include: receiving, from a connection database of a first user, connection data for each of one or more other users; determining a degree of connection of the one or more other users to the first user, based on the connection data; receiving query information from one or more electronic devices associated with the first user; receiving authentication information for each of the one or more other users; determining a destination of the first user based on the query information; determining one or more other user destinations for the one or more other users, based on the authentication information for the one or more other users; identifying one or more correlated other users from the one or more other users by comparing the destination of the first user with the one or more other user destinations of the one or more other users and further based on the degree of connection of the one or more other users; and providing the identified one or more correlated other users to the first user.

In some aspects, the techniques described herein relate to a computer-implemented method, the method including: a data storage device storing instructions for identifying correlated users in an electronic storage medium; and a processor configured to execute the instructions to perform a method including: receiving query information from one or more electronic devices associated with a first user; determining one or more other users associated with the first user by accessing a connection database; transmitting, to the one or more other users, an opt-in preference for opting in to communicating and sharing authentication information; receiving authentication information for each of the one or more other users, upon receiving indicia of opting in by the one or more other users; receiving, from the connection database of the first user, connection data for each of one or more other users based on receiving the authentication information for the one or more other users; determining a degree of connection of the one or more other users to the first user, based on the connection data; determining a destination of the first user based on the query information; determining one or more other user destinations for the one or more other users, based on the authentication information for the one or more other users; identifying one or more correlated other users from the one or more other users by comparing the destination of the first user with the one or more other user destinations of the one or more other users and further based on the degree of connection of the one or more other users; and transmitting, using a graphical user interface (GUI), the identified one or more correlated other users to the first user.

In some aspects, the techniques described herein relate to a system for identifying correlated users, the system including: receiving query information from one or more electronic devices associated with a first user; determining one or more other users associated with the first user by accessing a connection database; transmitting, to the one or more other users, an opt-in preference for opting in to communicating and sharing authentication information; receiving authentication information for each of the one or more other users, upon receiving indicia of opting in by the one or more other users; receiving, from the connection database of the first user, connection data for each of one or more other users based on receiving the authentication information for the one or more other users; determining a degree of connection of the one or more other users to the first user, based on the connection data; determining a destination of the first user based on the query information; determining one or more other user destinations for the one or more other users, based on the authentication information for the one or more other users; identifying one or more correlated other users from the one or more other users by comparing the destination of the first user with the one or more other user destinations of the one or more other users and further based on the degree of connection of the one or more other users; and transmitting, using a graphical user interface (GUI), the identified one or more correlated other users to the first user.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for identifying correlated users, according to one or more embodiments.

FIG. 2 depicts a flowchart of an exemplary method of identifying correlated users, according to one or more embodiments.

FIG. 3 depicts a visualization of a mapping for a first user and one or more potentially correlated users, according to one or more embodiments.

FIG. 4 depicts a portion of a graphical user interface, according to one or more embodiments.

FIG. 5 depicts an example of a computing device, according to one or more embodiments.

### DETAILED DESCRIPTION OF EMBODIMENTS

According to certain aspects of the disclosure, methods and systems are disclosed for identifying correlated users, e.g., identifying personal contacts of a first user who can provide recommendations to the first user when the first user visits a new geographic location. Travelers often struggle to find trusted recommendations for activities and restaurants when traveling to new places. Current search algorithms and computer-based methods, such as searching online or user-provided reviews, often produce generic and impersonal results, leading to a less enjoyable and personalized travel experience and suboptimal surfacing of recommendations to the user. This problem is even more pronounced for first-time travelers who may be unfamiliar with local culture and customs. For example, conventional techniques may not take into account the traveler's specific interests or preferences, resulting in recommendations that are not tailored to their individual needs. Additionally, these techniques may not consider the traveler's budget or the local customs and cultural nuances, which can significantly impact their overall travel experience. One of the main technical problems lies in the inability of current solutions to effectively consider correlations between users and connections when providing reviews and recommendations. This is may be due to the difficulty in determining the degree of connection between users and incorporating this information into personalized recommendations. Accordingly, improvements in technology relating to identifying correlated users, which assists in helping providing personalized recommendation, are needed.

As will be discussed in more detail below, in various embodiments, systems and methods are described for identifying correlated users. In some embodiments, by training a machine-learning model, e.g., via supervised or semi-supervised learning, to learn associations between user data and user correlation data, the trained machine-learning model may be usable to identify correlated users.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first user could be termed a second user, and, similarly, a second user could be termed a first user, without departing from the scope of the various described embodiments. The first user and the second user are both users, but they are not the same user.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Terms like “provider,” “merchant,” “vendor,” or the like may generally encompass an entity or person involved in providing, selling, and/or renting items to persons such as a seller, dealer, renter, merchant, vendor, or the like, as well as an agent or intermediary of such an entity or person. An “item” may generally encompasses a good, service, or the like having ownership or other rights that may be transferred. Terms like “user” or “customer” may generally encompasses any person or entity that may desire information, resolution of an issue, purchase of a product, or engage in any other type of interaction with a provider. The term “browser extension” may be used interchangeably with other terms like “program,” “electronic application,” or the like, and may generally encompass software that is configured to interact with, modify, override, supplement, or operate in conjunction with other software.

A “machine-learning model” may generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model may generally be trained using training data (e.g., experiential data and/or samples of input data), which may be fed into the model in order to establish, tune, or modify one or more aspects of the model (e.g., the weights, biases, criteria for forming classifications or clusters, or the like). Aspects of a machine-learning model may operate on an input linearly, in parallel, via a network (e.g., a neural network), or via any suitable configuration.

The execution of the machine-learning model may include deployment of one or more machine-learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

In an exemplary use case, a consumer may indicate through one or more user interactions and/or behaviors that they intend to visit a particular destination or that they are already located at a particular destination. A system, such as a computer system or a web portal accessed by the consumer, receives this indication and identifies one or more other users that have previously visited the location and that are connected or otherwise correlated with the consumer. A ranking may be provided to the consumer as to which users are the most highly suggested to the consumer for reaching out to or contacting for recommendations associated with the particular destination. The system then provides to the consumer either a suggestion or prompt to contact the one or more other users, and may initiate the contact process. The system may also provide the consumer with one or more review associated with the one or more users, if any reviews are available and associated with the particular destination.

In another exemplary use case, a machine-learning model may be trained to learn associations between a first user and one or more correlated users. In some embodiments such associations may be based on various factors such as similar demographics, interests, hobbies, or past behavior. The system may then use this model to identify and suggest other users that the first user may want to connect with or follow on a social network, messaging app, or other online platform. The machine-learning model may also be used to suggest content, products, or services that the first user may be interested in based on the behavior of other correlated users. The system may continuously update and refine the machine-learning model based on feedback and user interactions, improving the accuracy of the suggestions over time. Overall, these use cases demonstrate how data and machine-learning can be leveraged to provide personalized recommendations and enhance user experiences.

The data that the machine-learning model may use for training could include various types of information that could help establish correlations between users, such as demographic data, user behavior patterns, social connections, and other user-generated content such as posts, reviews, and ratings. This data may be obtained from a variety of sources such as social media platforms, e-commerce sites, and search engines, as well as through user feedback and surveys. Additionally, the machine-learning model may be trained using various techniques such as supervised learning, unsupervised learning, and reinforcement learning, depending on the nature of the data and the desired outcomes. Ultimately, the quality and relevance of the data used to train the model may play a role in determining the accuracy and effectiveness of the recommendations provided to users.

While several of the examples above involve correlations as they relate to a particular destination, it should be understood that techniques according to this disclosure may be adapted to any suitable type of correlation between users. It should also be understood that the examples above are illustrative only. The techniques and technologies of this disclosure may be adapted to any suitable activity.

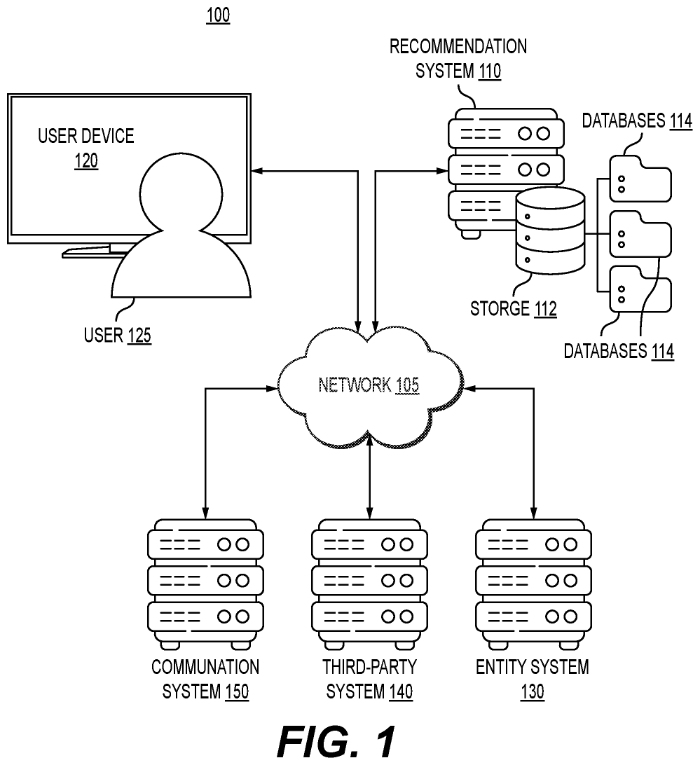

FIG. 1 depicts an exemplary environment 100 that may be utilized with techniques presented herein. One or more user device(s) 120, recommendation system 110, third-party system 140, entity (e.g., a financial entity) system 130, communication system 150, and/or one or databases (such as databases 114) and/or storages (such as storage 112) may communicate across an electronic network 105. As will be discussed in further detail below, one or more recommendation systems 110 may communicate with one or more of the other components of the environment 100 across electronic network 105. The one or more user device(s) 120 may be associated with a user 125, e.g., a user associated with a particular destination.

In some embodiments, the components of the environment 100 are associated with a common entity, e.g., a financial institution, transaction processor, merchant, social media platform, or the like. In some embodiments, one or more of the components of the environment 100 may be associated with a different entity than another. The systems and devices of the environment 100 may communicate in any arrangement. As will be discussed herein, systems and/or devices of the environment 100 may communicate in order to one or more of generate, train, or use a machine-learning model to identifying correlated users, among other activities.

The user device 120 may be configured to enable the user 125 to access and/or interact with other systems in the environment 100. For example, the user device 120 may be a computer system such as, for example, a desktop computer, a mobile device, a tablet, etc. In some embodiments, the user device 120 may include one or more electronic application(s), e.g., a program, plugin, browser extension, etc., installed on a memory of the user device 120. In some embodiments, the electronic application(s) may be associated with one or more of the other components in the environment 100. For example, the electronic application(s) may include one or more of a web browser enabling access to one or more websites, travel planning software, etc.

Each component and/or system displayed in the environment 100 may include a server system, an electronic data system, and/or computer-readable memory such as a hard drive, flash drive, disk, etc. Recommendation system 110 is depicted with storage 112, which includes one or more databases 114. It will be appreciated that each of the user device 120, entity system 130, third-party system 140, and communication system 150 may similarly include one or more storage, which may further include one or more databases.

In some embodiments, each component and/or system in the environment 100 includes and/or interacts with an application programming interface for exchanging data to other systems, e.g., one or more of the other components of the environment 100. Each component and/or system may include and/or act as a repository or source for user connection and/or location data. For example, one or more systems may include historical location data and/or transaction data for one or more users, enabling the system to build an understanding as discussed in more detail below.

In various embodiments, the electronic network 105 may be a wide area network (“WAN”), a local area network (“LAN”), personal area network (“PAN”), or the like. In some embodiments, electronic network 105 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

As discussed in further detail below, the recommendation system 110 may one or more of generate, store, train, or use a machine-learning model configured to identify correlations between users. The recommendation system 110 may include a machine-learning model and/or instructions associated with the machine-learning model, e.g., instructions for generating a machine-learning model, training the machine-learning model, using the machine-learning model, etc. The recommendation system 110 may include instructions for retrieving user correlation data (such as retrieving data from one or more databases 114 located on storage 112), adjusting user correlation data, e.g., based on the output of the machine-learning model, and/or operating a display to output user correlation data, e.g., as adjusted based on the machine-learning model.

In some embodiments, a system or device other than the recommendation system 110 may be used to generate and/or train the machine-learning model. For example, such a system may include instructions for generating the machine-learning model, the training data and ground truth, and/or instructions for training the machine-learning model. A resulting trained-machine-learning model may then be provided to the recommendation system 110.

Generally, a machine-learning model may include a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model.

In various embodiments, the variables of a machine-learning model may be interrelated in any suitable arrangement in order to generate the output. For example, the machine-learning model may include one or more convolutional neural network (“CNN”) configured to identify features in the user correlation data, and may include further architecture, e.g., a connected layer, neural network, etc., configured to determine a relationship between the identified features in order to determine a location in the user correlation data. In some instances, different samples of training data and/or input data may not be independent. Thus, in some embodiments, the machine-learning model may be configured to account for and/or determine relationships between multiple samples.

For example, in some embodiments, the machine-learning model of the recommendation system 110 may include a Recurrent Neural Network (“RNN”). Generally, RNNs are a class of feed-forward neural networks that may be well adapted to processing a sequence of inputs. In some embodiments, the machine-learning model may include a Long Short Term Memory (“LSTM”) model and/or Sequence to Sequence (“Seq2Seq”) model. An LSTM model may be configured to generate an output from a sample that takes at least some previous samples and/or outputs into account.

As further example, the machine-learning model of the recommendation system 110 may include one or more tensors. Generally, tensors may be multi-dimensional arrays that can represent complex data structures. In the context of machine-learning, tensors are commonly used to represent input data, model parameters, and output predictions. Tensors can have any number of dimensions, with each dimension representing a specific feature or attribute of the data. For example, a two-dimensional tensor could represent a matrix of pixel values in an image, while a three-dimensional tensor could represent a sequence of audio spectrograms over time. By using tensors to represent data, machine-learning models can easily manipulate and analyze large and complex datasets, making it possible to develop accurate and powerful recommendation systems.

As further example, the machine-learning model of the recommendation system 110 may include on or more transformers. Generally, a transformer is a type of neural network architecture commonly used in natural language processing (NLP) and other sequence-to-sequence tasks. A transformer model may consist of an encoder and a decoder, both of which use self-attention mechanisms to process input sequences. The self-attention mechanism may allow the model to attend to different parts of the input sequence at different levels of granularity, making it particularly effective for handling long sequences of text. In addition to self-attention, transformers may also use positional encoding to preserve the order of the input sequence and feedforward neural networks to transform the attention outputs.

In some embodiments, third-party system 140 may be a remote system associated with a third-party, such as a social media platform, a platform which provides and/or stores reviews, a cloud-based storage and sharing platform, or the like. Third-party system 140 may be any system or service that is provided by a third-party, which may or may not be directly controlled by the entity operating environment 100.

In some embodiments, a third-party system 140 may be utilized to solicit, host, and provide reviews for a particular destination. Such a third-party system 140 may enable businesses and destinations to receive reviews from customers and visitors, which are then hosted on the platform for potential customers and visitors to view. The third-party system 140 may also provide a rating system, such as a star rating or numerical rating, to facilitate the evaluation of the quality of the destination. Furthermore, the third-party system 140 may offer additional functionalities, including the ability for businesses and/or additional users to respond to reviews and receive analytics and insights into the reviews and ratings left by customers.

In some embodiments, third-party system 140 may be a social media platform that is utilized to facilitate communication and collaboration between users of Environment 100. The social media platform may offer a range of functionalities that can be leveraged by users to enhance their communication and collaboration, such as advanced messaging functionalities and the ability to share and collaborate on files and data sets.

In some embodiments, communication system 150 may be designed to facilitate communication between one or more users and/or one or more system. The communication system 150 may employ a range of technical components and protocols that enable the exchange of information between different devices, applications, and systems. In some embodiments, communication system 150 may comprise a set of hardware and software components that enable the transfer of data, voice, and video information between different endpoints. These endpoints may include systems, computers, smartphones, tablets, servers, routers, switches, and other network-connected devices. The communication system 150 may leverage various communication technologies such as Wi-Fi, Bluetooth, cellular networks, and Ethernet to establish connectivity between these endpoints.

In addition to the underlying hardware and software components, the communication system 150 may also employ various protocols and algorithms to ensure reliable and efficient communication. To ensure security and privacy, the communication system 150 may also employ various encryption and authentication mechanisms which may be used to encrypt data in transit, authenticate users and devices, and prevent unauthorized access to the network.

Although depicted as separate components in FIG. 1, it should be understood that a component or portion of a component in the environment 100 may, in some embodiments, be integrated with or incorporated into one or more other components. For example, one or more storage database 114 may be integrated within storage 112, which itself may be integrated within recommendation system 110, or the like. In another example, the recommendation system 110 may be integrated into the entity system 130. In some embodiments, operations or aspects of one or more of the components discussed above may be distributed amongst one or more other components. Any suitable arrangement and/or integration of the various systems and devices of the environment 100 may be used.

Further aspects of the machine-learning model and/or how it may be utilized to identify correlated users are discussed in further detail in the methods below. In the following methods, various acts may be described as performed or executed by a component from FIG. 1, such as the recommendation system 110, the user device 120, or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

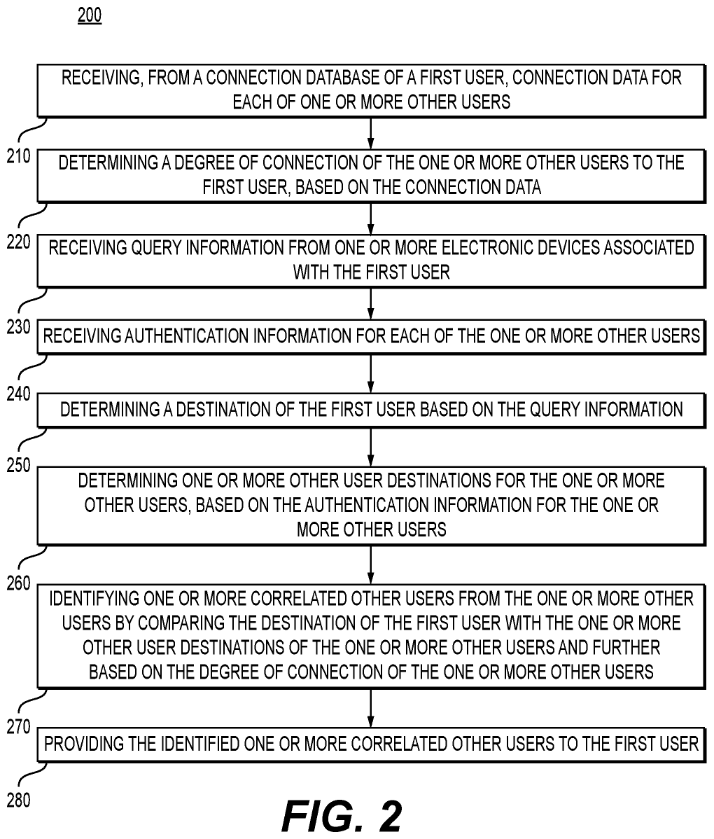

FIG. 2 illustrates an exemplary process 200 for using a machine-learning model to identify correlated users, such as in the various examples discussed above. The method may be prompted by and/or otherwise include an interaction from one or more users (such as user 125), such as a user indication that the user is interested in a particular destination or that the user is located at a particular destination.

At step 210, the method may include receiving connection data from each of one or more users. The connection data may be received from one or more databases, such as a database associated with one or more systems shown in environment 100, such as recommendation system 110 (and databases 114), third-party system 140 (which may be a system related to one or more social media platforms); entity system 130, or the like. One or more of such databases may be considered a connection database. The connection data may be related to a first user, such as user 125 of user device 120.

The connection data may encompass data related to one or more connections between two or more users within various digital contexts, such as social media platforms, online communities, or contact lists on personal devices. In certain embodiments, one of these users may be the first user. It is important to note that the terms “friends” and “groups” may refer to the virtual connections and associations formed on digital platforms or between personal devices. For instance, the connection data might include information on which users are “friends” on a social media platform, suggesting that they have mutually agreed to connect with one another and share updates, posts, or content. Similarly, the term “groups” can refer to virtual communities formed by users with common interests or affiliations on a digital platform.

Additionally, the connection data may cover instances where users have saved each other as contacts on one or more of their personal devices, such as smartphones or computers. This information can provide insights into the technical connections and communication channels established between users beyond the scope of social media.

Furthermore, the connection data may encompass information about which users follow each other on digital platforms, indicating that one user has chosen to receive updates or content from another user without necessarily forming a mutual “friendship.” The data can also include details about which users are members of the same virtual group, highlighting their shared interests or affiliations on the platform. Moreover, the connection data may include instances in which users have interacted with each other in a specific way, such as by sharing content, commenting on each other's posts or feeds, or exchanging messages through various communication channels.

The connection data may include information on which users are connected as friends on a particular social network or platform. For instance, a social media platform's API may be used to retrieve data on which users are friends on that particular social media platform. The connection data may include information on followers of one or more users. This may include information on which users follow or subscribe to the updates of other users on a social media platform. For example, a social media platform's API may be used to retrieve data on which users follow each other on the social media platform. The connection data may include information on group membership data. This may include information on which users are members of the same group or community on a social media platform. For example, a social media platform's API may be used to retrieve data on which users are members of the same social media platform group. The connection data may include interaction data, which may include information on which users have interacted with each other in a particular way on a social media platform. For example, the data may include information on which users have shared content, commented on each other's posts or feed, or liked (or otherwise interacted with) each other's content on a particular platform.

One way in which the system may collect connection data is by requesting access to one or more user contact lists located on the device of the user (e.g., user device 120). This may be done through an opt-in process, where the user device 120 presents the user with a prompt or message asking for permission to access their contact list and the user may subsequently provide an opt-in preference.

Once the user has granted permission, the system may extract relevant information from the contact list, such as the names, e-mail addresses, phone numbers, and social media profiles of the user's contacts. One or more systems, such as the recommendation system 110, entity system 130, or the like, may then cross-reference one or more of this information with the profiles or one or more other users on the same social media platform, e.g., by using techniques such as e-mail matching, phone number matching, or social media profile matching, etc.

The result of this matching process may be a set of potential social connections between the user and other users on the platform. The system may then use further analysis and clustering techniques to identify social groups within the overall network of users, based on these potential connections.

At step 220, the method may include determining a degree of connection of the one or more other users to the first user. The degree of connection can be a versatile and multifaceted metric that evaluates the strength or closeness of the relationship between the first user and each of the other users in the network. This metric may be based on the connection data and other relevant factors, such as geographic factors.

The degree of connection may be determined at varying levels of granularity, providing flexibility in assessing the relationships between users. For example, a high-level assessment might simply classify the connection as “strong,” “moderate,” or “weak” based on predefined thresholds. A more fine-grained analysis might quantify the connection on a continuous scale, such as a score ranging from 0 to 100, where a higher score indicates a stronger connection.

In some embodiments, the degree of connection may be determined using various metrics or algorithms, such as a social network analysis algorithm or a machine-learning model. These metrics or algorithms may take into account factors such as the frequency and type of interactions between the users (e.g., likes, comments, or direct messages), the number of common connections (e.g., mutual friends or shared group memberships), the similarity of their interests or demographics (e.g., age, location, or hobbies), or the like.

For example, the degree of connection may be classified, such as strong, moderate or weak. For a strong connection, in one example, the users may frequently interact with each other's content, have many mutual friends, and share similar interests. Their connection score might be 85 out of 100. For a moderate connection, for example, the users may occasionally interact with each other's content, have a few mutual friends, and share some interests. Their connection score might be 50 out of 100. For a weak connection, in one example, the users may rarely interact with each other's content, have no mutual friends, and do not share interests. Their connection score might be 15 out of 100.

At step 230, the method may include receiving query information from one or more electronic devices (such as user device 120) associated with the first user. The term “query information,” may refer to any data or input provided by the first user that reflects their interests, preferences, or intentions regarding a particular destination or topic. Such query information may be related to one or more particular destinations of interest to the first user, such as a specific geographic area of interest or one or more particular attractions related to the destination.

To provide a few specific examples, query information may include: a text-based search query entered by the user, such as “best restaurants in Paris” or “top tourist attractions in New York City”; social media activity, such as the user liking, sharing, or commenting on posts about a specific destination or attraction; location data, such as the user's current location or a list of places they have visited in the past; or the like. Query information may encompass one or more types of data, such as search queries of the user, social media activity of the user, location data of the user, travel and/or event bookings of the user, user profile information, or the like.

At step 240, the method may include receiving authentication information for each of the one or more other users. Such authentication information may be in the form of an agreement to share data regarding one or more connections to one or more other users. Such authentication may, in some embodiments, be an indication to be included as a possible contact to one or more other users if a determination is made that the user providing the authentication is correlated to one or more other users. The authentication may include one or more levels of authentication, which may be related to certain levels of identity disclosure. For example, the authentication may involve the user providing their full name, e-mail address, and phone number, or it may involve a more limited disclosure, such as only providing their e-mail address. By way of another example, the authentication may include and/or be limited to the user being associated with a user ID, which is generally anonymous and may be stored with other data without necessarily linking the user ID to any personally identifiable information of the user.

The authentication information may be obtained through various means, such as a user agreement or opt-in process, where the user explicitly consents to sharing their data and being included as a possible contact for other users. The authentication information may be stored securely and used only for the purposes specified in the user agreement or opt-in process.

In some embodiments, the authentication information may be used to indicate the user's willingness to be included as a possible contact for other users, based on the determination of the user's correlation to other users. This may involve analyzing the connection data and other relevant factors to determine the strength of the user's connections to other users, and using this information to identify potential contacts or social groups.

The authentication may include one or more levels of authentication, which may be related to certain levels of identity disclosure. For example, a user may provide a higher level of authentication if they are willing to share more personal information or disclose their identity to a greater extent. The level of authentication may also impact the user's ranking or visibility within the network, based on the strength and authenticity of their connections.

At step 250, the method may include determining a destination of the first user based on the query information. The method may include utilizing the query information and one or more other data associated with the user to determine a particular destination, such as a particular city, geographic location, an accommodation, an establishment, an attraction, or the like. For example, the method may use natural language processing techniques to extract location information from the user's search queries or text messages. The method may also use Global Positioning Service (GPS) location data (e.g., from a user device associated with the first user such as user device 120) or other location data to identify the user's current or past locations. Further, the method may utilize one or more user behaviors and/or interests, such as a reservation of a user or a visit by the user to a particular establishment, or the user generating an itinerary associated with the particular destination, or any other key identifiers which may show an interest from the user in a particular location. In some embodiments, a single source of query information may be satisfactory to establish a user interest in a particular location, while in some embodiments, the system may utilize indications from multiple types of data as query information to determine a user interest in a particular location.

At step 260, the method may include determining one or more other user destinations for the one or more other users. User destinations, broadly defined, may refer to locations or points of interest that are associated with or visited by other users within the context of the digital platform or service. These destinations can be identified and characterized using various technical aspects of the data defining a user destination. For example, user destinations may be determined based on geotagged content, where users may share posts, photos, or videos that are tagged with specific geographic coordinates, indicating the location of the content. By way of another example, user destinations may be determined based on check-ins, where users may “check-in” to a location, such as a restaurant, museum, or park, using the digital platform. One or more systems within environment 100 may aggregate these check-ins to determine popular user destinations. In some embodiments, the system may collect location data from user devices, such as smartphones or wearables, to determine the destinations users frequently visit or spend time at. In some embodiments, the system may identify user-associated lists of favorite places or write reviews about specific destinations. By analyzing this user-generated content, the system can identify popular or highly-rated user destinations. Such determination may be made utilizing one or more data associated with the one or more other users. In some embodiments, the data is provided by the respective user during the authentication process for the one or more other users, such as an agreement to share location data and/or location history data. Further, the authentication may include an agreement to share one or more other type of data which may be relevant in determining user destinations, such as transaction data (which may be associated with one or more user account and/or one or more financial system), social media data, or the like. The method may also utilize other sources of data to determine user destinations, such as public data sources, third-party data providers (such as third-party system 140), or data obtained from sensors or devices in the environment 100.

In some embodiments, the data and/or information received is utilized to determine one or more user destinations. This may be done by training a machine-learning model to analyze and interpret the data and/or information received, and to identify patterns or relationships that can be used to predict user destinations. The machine-learning model may be trained using various techniques, such as supervised learning, unsupervised learning, or reinforcement learning, and may be based on different types of algorithms, such as decision trees, neural networks, or support vector machines.

During the training process, the machine-learning model may be provided with a large dataset of historical data, such as user location data, transaction data, social media data, or other relevant data, along with corresponding user destinations. The model may then use this data to learn the underlying patterns and relationships between the input data and the output destinations. Once the model has been trained, it can be used to predict user destinations based on new input data, such as real-time location data or other relevant data.

In some embodiments, the machine-learning model may be continuously updated and refined over time, based on new data and feedback from users. This can help to improve the accuracy and reliability of the predictions, and to adapt to changing user preferences and behavior patterns.

At step 270, the method may include identifying one or more correlated other users from the one or more other users. The term “correlated other users” may refer to users who share similarities or connections with the first user, such as interests, preferences, behaviors, or social connections. These correlations may be based on factors such as shared destinations, degree of connection, or other user-specific information. For example, correlated other users may include, but is not limited to: users who have visited the same destinations as the first user; users who have a high degree of connection with the first user, such as mutual friends or frequent interactions; users who share similar interests, preferences, or demographic characteristics with the first user; or the like.

The identification may be performed by comparing the destination of the first user with one or more other user destinations of the one or more other users. This identification may further be based on the degree of connection between one or more other users and the first user. The term “degree of connection,” defined nonlimitingly, represents the strength or closeness of the relationship between the first user and each of the other users in the network. For example, the degree of connection may include: direct (or first-degree) connections, such as users who are directly connected to the first user, such as friends or followers on a social media platform; second-degree connections, such as users who are connected to the first user through a mutual friend or shared connection; 3third-degree connections, such as users who are connected to the first user through a chain of two intermediary connections; or the like. For example, if the first user has a direct (or first) degree of connection with one or more other users, the one or more other users may be determined to be of higher correlation to the first user.

Further, the method may include comparing transaction data from one or more users who are associated with the first user, the transaction data indicating a historic relation to the particular destination. In some embodiments, a degree of correlation of the one or more other users to the first user may be based on one or more of a purchase history overlap, one or more interactions between the first user and the one or more other users, an indicated level of trust by the first user to the one or more other users, or the like. Such an indication of trust may be, in some embodiments, established social media connections, prior interactions between the first user and the one or more other users, identification of the one or more other users as contacts stored on a user device of the first user, geographical data associated with the first user and the one or more correlated users (such as GPS data, for example, showing the first user lives and/or works with the one or more other user), or the like. The determination of the degree of the correlation between the first user and one or more other users may be completed by training and applying a machine-learning model, as discussed herein. The machine-learning model may be trained on data that includes information regarding historical correlations between one or more correlated users, which may identify historical one or more correlated other users. For example, the machine-learning model may be trained on data that includes information such as the frequency and duration of interactions between the users, shared interests or hobbies, common social network connections, trends within financial transaction data, or other relevant factors that may indicate a high degree of correlation between the users.

Once the machine-learning model has been trained, it can be applied to new data to determine the degree of correlation between the first user and one or more other users. The input data may include information such as user profiles, location data, transaction data, social media data, or user-provided data regarding contacts, which can be used to infer the degree of correlation between the users.

In some embodiments, the determination of the degree of correlation may also take into account user preferences and behavior patterns. For example, users who frequently visit the same types of locations, or who have similar transportation habits, may be considered more correlated than users who have very different preferences or habits.

At step 280, once one or more correlated other users have been identified (and potentially ranked based on degree of correlation), the method may include providing the identified one or more correlated other users to the first user. This may include receiving, by the first user via a graphical user interface, an indication and/or a selection of one or more correlated users. For example, the first user may be presented with a second user, the second user being one or the one or more correlated other users. The method may further include the first user selecting the second user, which may further include triggering a communication system 150 to initiate communication between the first user and the second user. Such a communication system 150 may be implemented using various communication technologies, such as SMS, e-mail, instant messaging, or voice calls. The selection of the second user may be based on various criteria, such as the degree of correlation between the first user and the second user, the proximity of the second user to the first user, or the availability and preferences of the second user.

Once the second user has been selected, the communication system 150 may be triggered to initiate communication between the first user and the second user. For example, a notification may be sent to the second user indicating that the first user is seeking to connect with them, and providing information about the purpose and context of the connection request. In some embodiments, the method may include automatically triggering the communication system 150 to initiate communication between the first user and second user. Such automatic communication may be based on one or more trigger or event, such as the selection of the second user or any one or more other events and steps as discussed herein. The communication system 150 may automatically provide a notification to one or more user informing them of the communication and/or of a communication opportunity, such as a notification prompting one or more user to take action, if necessary.

In some embodiments, the communication system 150 may also provide additional features and functionality to facilitate communication between the users. For example, the communication system 150 may provide real-time translation services to overcome language barriers or may provide video conferencing or screen sharing capabilities to enable collaborative work or problem-solving.

In some embodiments, the identity of the second user may be concealed for part of the process or the entirety of the process. The identity of the second user may be concealed to protect the privacy and security of the second user, or to prevent unwanted communications or solicitations. In such embodiments, the communication system 150 may utilize various techniques to conceal the identity of the second user, such as generating a temporary or anonymous user ID, encrypting or obfuscating user data, or routing communications through a secure or anonymized network.

The concealment of the second user's identity may be implemented in various stages of the process. For example, the initial selection of the second user may be based on anonymous or aggregate data, such as user profiles or location data, rather than directly identifying the user. Similarly, the communication system 150 may provide a secure and private channel for communication between the users, without revealing the actual identity or contact information of the second user.

In some embodiments, the concealment of the second user's identity may be optional or customizable, allowing the user to choose whether or not to disclose their identity to the first user. This can provide additional flexibility and control for the user, while still enabling them to connect and collaborate with others in a safe and secure manner.

The method may further include determining whether a determined destination of the first user is/was visited by the first user. Such a determination may be made by utilizing various types of data and information associated with the first user, such as location data, transaction data, or social media data. For example, the method may compare the current or planned destination of the first user to their past location history data, to determine whether they have previously visited the same location. One exemplary way to determine that the first user is visiting/has visited the particular destination is utilizing GPS data from a user device of a user.

The method may further include prompting the first user to provide and/or generate a review of the destination. Such an indication of review may be solicited using various techniques, such as sending a notification or message to the user via a mobile application or web interface, or displaying a prompt or survey on the user's device or browser. The prompt may ask the user to provide feedback or a rating of the destination, based on their experience visiting the location.

In some embodiments, the prompt may be customized based on the user's preferences or behavior patterns. For example, the prompt may be designed to encourage/reward users who have visited the destination multiple times, or who have previously provided feedback or ratings, to provide additional feedback or to share their experiences with others.

Once the user has provided and/or generated a review of the destination, the method may collect and analyze this feedback to generate personalized recommendations and services for the user, as well as for other users who may be interested in visiting the same location. For example, the feedback may be used to improve the quality of one or more recommendations, provided to one or more users, associated with the destination, to identify areas for improvement or growth, or to generate recommendations for other businesses or attractions in the area.

In some embodiments, one or more reviews may be utilized as a form of communication between a first user and one or more correlated users. In some embodiments, once one or more correlated users has been identified, the method may include identifying one or more reviews made by the one or more correlated users. Where a review is identified, the method may include surfacing or otherwise providing said review to the first user and may further include providing to the first user an option to contact the one or more correlated users, such as discussed herein. Where a review by the one or more correlated users is not identified or does not exist, the system may initially prompt the one or more correlated users to provide a review. This prompt may be generated using various techniques, such as sending a notification or message to the user via a mobile application or web interface, or displaying a prompt or survey on the user's device or browser. The prompt may ask the user to provide feedback or a rating of the destination or service, based on their experience.

In some embodiments, the prompt may be personalized based on the user's preferences or behavior patterns. For example, the prompt may be designed to encourage users who have visited the destination multiple times, or who have previously provided feedback or ratings, to provide additional feedback or to share their experiences with others.

Once the correlated user has provided a review, the system may surface or otherwise provide the review to the first user, along with an option to contact the correlated user. The contact option may be implemented using various communication technologies, such as SMS, email, instant messaging, or voice calls.

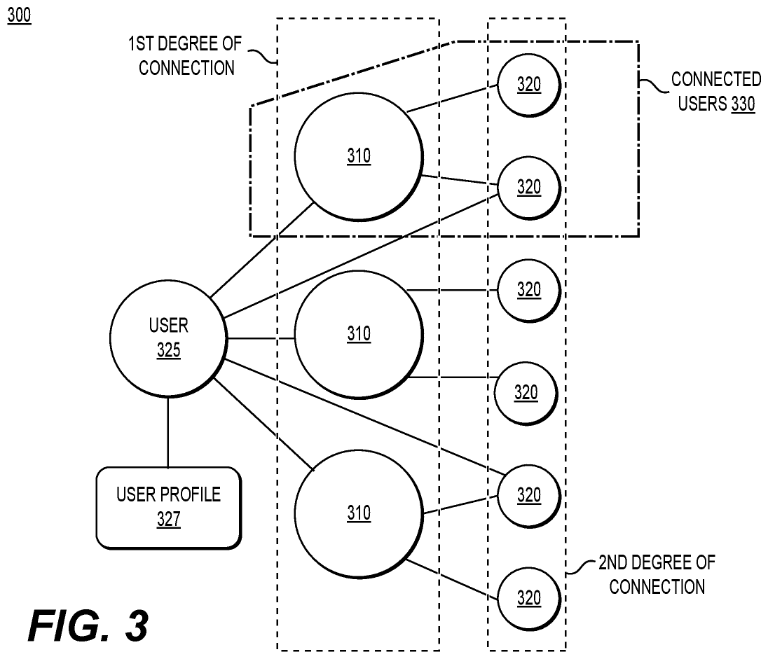

FIG. 3 illustrates a conceptual mapping of one or more users correlated to a first user, such as user 325. User 325 may be linked to one or more user profile, such as user profile 327. In some embodiments, user profile 327 is associated with one or more systems described herein, such as a recommendation system 110 and/or entity system 130.

The user profile associated with the first user may include information related to the user's preferences, behaviors, and other relevant characteristics. Such information may be collected from various sources, such as user interactions with the system, feedback provided by the user, and data obtained from external sources. The user profile may be stored in a database or other data storage means and updated periodically based on the user's interactions with one or more system. For example, information related to a user profile may be stored in one or more databases 114 within one or more storages 112 associated with the recommendation system 110.

The user profiles associated with one or more users correlated to the first user may be used to provide personalized recommendations and other services to the user. For example, the recommendation system 110 may analyze the user profiles to identify similar users or groups of users and recommend products or services based on their past interactions with the system. Similarly, the entity system 130 may use the user profiles to offer customized financial products or services that meet the user's specific needs and preferences.

depicts a visualization 300 of a mapping for a first user and one or more potentially correlated users. FIG. 3 demonstrates how one or more additional users (310, 320) may be correlated with the first user 325. The first user 325, by way of one or more connections, links, or correlations to one or more other users as described herein, may have one or more other users who are considered to be of high correlation. Such one or more other users of high correlation may be considered a user with a 1^{st} degree of connection (310) to the user 325.

The degree of connection between user 325 and the one or more other users of high correlation may be established through various means, such as similarity in their browsing or purchase history, shared interests or preferences, or other factors that indicate a high likelihood of similar behavior or interests, such as the various personal connection correlations discussed herein. In some embodiments, one or more machine-learning model may be used to analyze the data and identify users with high correlation to user 325.

The degree of connection between user 325 and other users may be further classified into multiple levels of connection, such as 2nd degree (320), 3rd degree, and so on. Each level of connection corresponds to a progressively lower degree of correlation with user 325. The identification of users with high correlation to user 325 and the establishment of their degree of connection may be used to provide personalized recommendations and other services to the user based on the behavior and preferences of users with similar characteristics.

Further, once a degree of correlation is established for each of the one or more users, an indication of which of these users are connected (330) to the first user 325 may be provided. Such a connection may be an established social media and/or personal connection as described herein. Thus, the system may establish which users are both correlated (which may include a ranking of correlation) and connected to the first user 325.

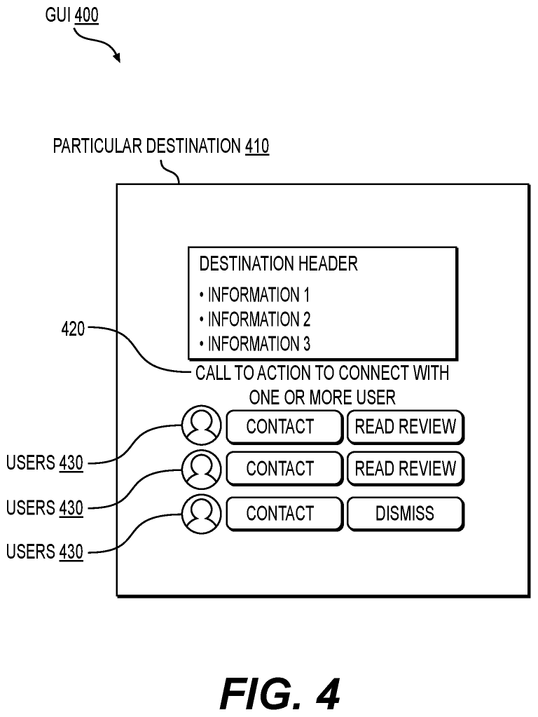

Referring to FIG. 4, the system may further include displaying a graphical user interface (GUI) 400 to one or more users, such as the first user. The GUI 400 may include information on the particular destination 410, specific information relating to one or more attractions or specific items of interest associated with the destination, a call to action 420 related to one or more additional users, and one or more identifiers of one or more additional users 430, the identifier potentially including interactive elements facilitating information transfer between the one or more additional user 430 and the first user.

The one or more additional users 430 presented to the first user may be users which are both highly correlated and connected to the first user. Where the one or more additional user 430 has previously provided a review (such as a review of the particular destination and/or of a specific attraction or item associated with the particular designation), the GUI may include an interactive element facilitating access to the review. The interactive element may further include a button or element which initiates a communication between the first user and the one or more additional users, such as described in exemplary embodiments herein. The interactive element may further include one or more additional elements which may be of use to the first user, such as a button to dismiss one or more of the one or more additional users, which in some embodiments may surface or prompt the system to provide the next highest ranked one or more users which are both correlated and connected.

It should be understood that embodiments in this disclosure are exemplary only, and that other embodiments may include various combinations of features from other embodiments, as well as additional or fewer features. For example, while some of the embodiments above pertain to correlated users for a particular destination, any suitable activity may be used. In an exemplary embodiment, instead of or in addition to finding correlated users to a particular destination, correlated users may be found and/or identified based one or more user associations with one or more other activities, such as purchasing behavior, search history, or other user interactions. Additionally, some embodiments may include incorporating user feedback, ratings, or other user-generated content to improve the accuracy and relevance of recommendations.

In general, any process or operation discussed in this disclosure that is understood to be computer-implementable, such as the processes illustrated in FIGS. 2-4, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

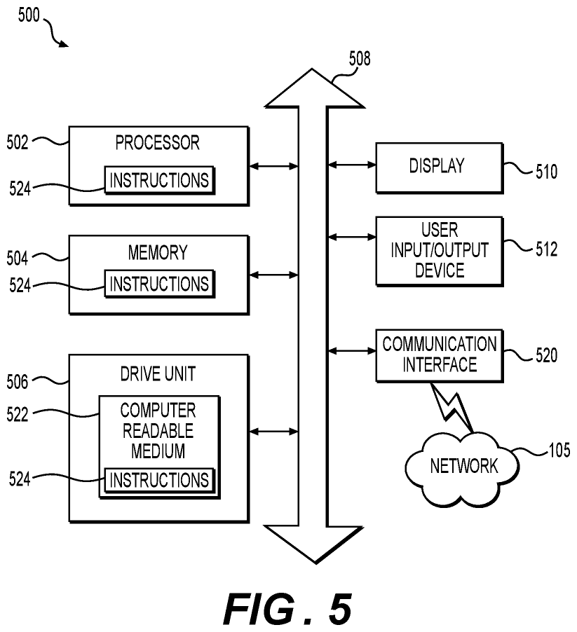

FIG. 5 is a simplified functional block diagram of a computer 500 that may be configured as a device for executing the methods of FIGS. 2-4, according to exemplary embodiments of the present disclosure. For example, the computer 500 may be configured as the recommendation system 110 and/or another system according to exemplary embodiments of this disclosure. In various embodiments, any of the systems herein may be a computer 500 including, for example, a data communication interface 520 for packet data communication. The computer 500 also may include a central processing unit (“CPU”) 502, in the form of one or more processors, for executing program instructions. The computer 500 may include an internal communication bus 508, and a storage unit 506 (such as ROM, HDD, SDD, etc.) that may store data on a computer readable medium 522, although the computer 500 may receive programming and data via network communications. The computer 500 may also have a memory 504 (such as RAM) storing instructions 524 for executing techniques presented herein, although the instructions 524 may be stored temporarily or permanently within other modules of computer 500 (e.g., processor 502 and/or computer readable medium 522). The computer 500 also may include input and output ports 512 and/or a display 510 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method comprising:
receiving, from a connection database of a first user, connection data for each of one or more other users;
determining a degree of connection of the one or more other users to the first user, based on the connection data;
receiving query information from one or more electronic devices associated with the first user;
receiving authentication information for each of the one or more other users;
determining a destination of the first user based on the query information;
determining one or more other user destinations for the one or more other users, based on the authentication information for the one or more other users;
identifying one or more correlated other users from the one or more other users by comparing the destination of the first user with the one or more other user destinations of the one or more other users and further based on the degree of connection of the one or more other users; and
providing the identified one or more correlated other users to the first user.

2. The computer-implemented method of claim 1, wherein identifying the one or more correlated other users is performed using a machine-learning algorithm trained based on historical one or more correlated other users.

3. The computer-implemented method of claim 1, wherein the identifying the one or more correlated other users is based on a Global Position Service (GPS) location of the first user and a GPS location of the one or more other users.

4. The computer-implemented method of claim 1, wherein the destination of the first user may comprise a one or more of a geographic location, an accommodation, an establishment, or an attraction.

5. The computer-implemented method of claim 1, wherein the degree of connection of the one or more other users is based on one or more of a purchase history overlap, an interaction, or an indicated level of trust with the first user.

6. The computer-implemented method of claim 1, further comprising using a GPS location of the first user to update the identified one or more correlated other users.

7. The computer-implemented method of claim 1, further comprises:
receiving, from the first user via a graphical user interface (GUI), a selection of a second user of the one or more correlated other users; and
upon selecting the second user from the one or more correlated other users, automatically triggering a communication system to initiate communication between the first user and the second user.

8. The computer-implemented method of claim 1, further comprising:
determining, using GPS data of the first user, whether the determined destination of the first user is visited by the first user; and
prompting the first user to indicate a review for the destination visited by the first user.

9. The computer-implemented method of claim 1, further comprising:
requesting authorization from the identified one or more correlated other users to share authentication information with the first user.

10. The computer-implemented method of claim 1, further comprising:
concealing identification of the one or more correlated other users from the first user.

11. A computer-implemented method, the method comprising:
a data storage device storing instructions for identifying correlated users in an electronic storage medium; and
a processor configured to execute the instructions to perform a method including:
receiving query information from one or more electronic devices associated with a first user;
determining one or more other users associated with the first user by accessing a connection database;
transmitting, to the one or more other users, an opt-in preference for opting in to communicating and sharing authentication information;
receiving authentication information for each of the one or more other users, upon receiving indicia of opting in by the one or more other users;
receiving, from the connection database of the first user, connection data for each of one or more other users based on receiving the authentication information for the one or more other users;
determining a degree of connection of the one or more other users to the first user, based on the connection data;
determining a destination of the first user based on the query information;
determining one or more other user destinations for the one or more other users, based on the authentication information for the one or more other users;
identifying one or more correlated other users from the one or more other users by comparing the destination of the first user with the one or more other user destinations of the one or more other users and further based on the degree of connection of the one or more other users; and
transmitting, using a graphical user interface (GUI), the identified one or more correlated other users to the first user.

12. The method of claim 11, wherein identifying the one or more correlated other users is performed using a machine-learning algorithm trained based on historical one or more correlated other users.

13. The method of claim 11, wherein the identifying the one or more correlated other users is based on a GPS location of the first user and a GPS location of the one or more other users.

14. The method of claim 11, wherein the destination of the first user may comprise a one or more of a geographic location, an accommodation, an establishment, or an attraction.

15. The method of claim 11, wherein the degree of connection of the one or more other users is based on one or more of a purchase history overlap, an interaction, or an indicated level of trust with the first user.

16. The method of claim 11, further comprising using a GPS location of the first user to update the identified one or more correlated other users.

17. The method of claim 11, further comprises:
receiving, from the first user via a graphical user interface (GUI), a selection of a second user of the one or more correlated other users; and
upon selecting the second user from the one or more correlated other users, automatically triggering a communication system to initiate communication between the first user and the second user.

18. The method of claim 11, further comprising:
determining, using GPS data of the first user, whether the determined destination of the first user is visited by the first user; and
prompting the first user to indicate a review for the destination visited by the first user.

19. The method of claim 11, further comprising:
requesting authorization from the identified one or more correlated other users to share authentication information with the first user.

20. A system for identifying correlated users, the system including:
receiving query information from one or more electronic devices associated with a first user;
determining one or more other users associated with the first user by accessing a connection database;
transmitting, to the one or more other users, an opt-in preference for opting in to communicating and sharing authentication information;
receiving authentication information for each of the one or more other users, upon receiving indicia of opting in by the one or more other users;
receiving, from the connection database of the first user, connection data for each of one or more other users based on receiving the authentication information for the one or more other users;
determining a degree of connection of the one or more other users to the first user, based on the connection data;
determining a destination of the first user based on the query information;
determining one or more other user destinations for the one or more other users, based on the authentication information for the one or more other users;
identifying one or more correlated other users from the one or more other users by comparing the destination of the first user with the one or more other user destinations of the one or more other users and further based on the degree of connection of the one or more other users; and
transmitting, using a graphical user interface (GUI), the identified one or more correlated other users to the first user.
